(19) United States
(12) Patent Application Publication
(10) Pub. No.: US 2024/0140711 A1
(43) Pub. Date: May 2, 2024

(54) Loading Assistance Device

(71) Applicant: Daifuku Co., Ltd., Osaka-shi (JP)

(72) Inventors: Tomohito Tanaka, Tokyo (JP); Makoto Sakashita, Tokyo (JP); Takeshi Nakanishi, Tokyo (JP)

(21) Appl. No.: 18/385,767

(22) Filed: Oct. 31, 2023

(30) Foreign Application Priority Data
Nov. 1, 2022 (JP) 2022-175700

(51) Int. Cl. B65G 1/137

(52) U.S. Cl. CPC B65G 1/1371; B65G 2203/0216

(57) ABSTRACT

A loading assistance device includes an infeed unit to which a plurality of articles are transported, a work area, a transporter that transports the plurality of articles from the infeed unit to the work area, a reader that reads identification information on the plurality of articles, a writer that writes operation assistance information on a surface of each of the plurality of articles, and a control system. The work area includes a plurality of work sections in which supports are placed. The operation assistance information includes section specification information specifying a work section of the plurality of work sections for each of the plurality of articles to undergo loading. The control system generates the section specification information to be written on each of the plurality of articles based on the identification information to allow articles in a same category to be preferentially loaded onto a same support of the supports.

### CROSS-REFERENCE TO RELATED APPLICATION

This application claims priority to Japanese Patent Application No. 2022-175700 filed Nov. 1, 2022, the disclosure of which is hereby incorporated by reference in its entirety.

### BACKGROUND OF THE INVENTION

### Field of the Invention

The present invention relates to a loading assistance device that assists in loading of multiple articles with readable identification information indicating their article categories onto supports based on their article categories.

### Description of Related Art

An example loading assistance device is described in Japanese Unexamined Patent Application Publication No. 10-025022 (Patent Literature 1). Reference signs in parentheses used hereafter in describing the background are the reference signs in Patent Literature 1. The loading assistance device (sorter 40) in Patent Literature 1 includes a conveyor (14) that successively transports articles (10) in the same category from a storage rack (15), a writer (printer 20) adjacent to the conveyor (14), and a reader (reader 30) downstream from the writer and adjacent to the conveyor (14). Multiple chutes (13) connected to the conveyor (14) are arranged downstream from the reader. The writer prints automatic reading sorting information (11) and visual check sorting information (12) on each of the articles (10) in the same category transported by the conveyor (14). The reader then reads the automatic reading sorting information (11) on the articles (10) to automatically sort the articles (10) into a predetermined one of the chutes (13). An operator then sorts the articles (10) sorted into each chute (13) into, for example, a predetermined cart while checking the visual check sorting information (12).

Articles in different categories may be concurrently stored into or retrieved from, for example, an automated storage described in Patent Literature 1. For example, articles in different categories transported by a transporter may be concurrently sorted and loaded onto supports (such as carts or pallets) by their article categories. When fewer articles belong to each article category, articles in different categories may be loaded together onto a single support to allow the single support to be loaded with many articles. In these cases, the loading accuracy is to be improved with fewer loading errors such as an operator loading an article on a wrong support to the minimum.

### SUMMARY OF THE INVENTION

Thus, in view of the foregoing, a loading assistance device is awaited for facilitating loading of articles based on the article categories and for improving loading accuracy.

A loading assistance device according to an aspect of the present disclosure is a loading assistance device for assisting in loading of a plurality of articles each with identification information indicating a category of the article onto supports based on the article category. The identification information is readable. The loading assistance device includes an infeed unit to which the plurality of articles are transported, a work area in which an operator performs the loading, a transporter that transports the plurality of articles from the infeed unit to the work area along a predetermined transport path, a reader located along the transport path to read the identification information on the plurality of articles, a writer located between the reader and the work area along the transport path to write operation assistance information on a surface of each of the plurality of articles, and a control system that controls the reader and the writer. The work area includes, along the transport path, a plurality of work sections in which the supports are placed. The operation assistance information includes section specification information specifying a work section of the plurality of work sections for each of the plurality of articles to undergo the loading. The control system generates the section specification information to be written on each of the plurality of articles based on the identification information read by the reader to allow articles in a same category to be preferentially loaded onto a same support of the supports.

The device with this structure writes, on the surface of each article, operation assistance information including section specification information that specifies the work section for loading the article. The article with the operation assistance information is transported to the work area by the transporter. Thus, for example, the operator simply performing an operation in the work area based on the operation assistance information on each article can preferentially load articles in the same article category onto the same support. The device can thus facilitate loading performed by, for example, an operator, and reduce loading errors caused by, for example, an operator.

Thus, the loading assistance device with this structure is awaited for facilitating loading of articles based on their article categories and for improving loading accuracy.

Further features and advantages of the loading assistance device are clarified from exemplary and nonlimitative embodiments described below with reference to the drawings.

### BRIEF DESCRIPTION OF DRAWINGS

FIG. 1 is a schematic diagram of a loading assistance device.

FIG. 2 is a control block diagram.

FIG. 3 is a schematic perspective view of an article (carton).

FIG. 4 is a control flowchart.

FIG. 5 is a control flowchart.

FIG. 6 is a control flowchart.

### DESCRIPTION OF THE INVENTION

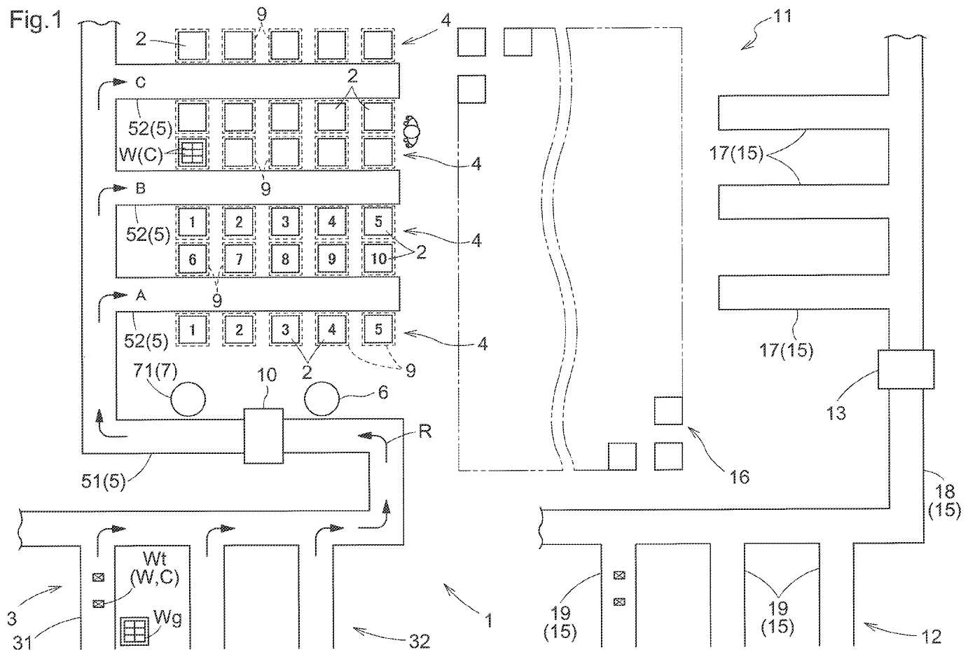

An example loading assistance device 1 in an article transport system 11 will now be described with reference to the drawings. In the present embodiment, as shown in FIG. 1, the article transport system 11 includes the loading assistance device 1, a storage 16 that stores articles W, a shipment conveyor 15, an attaching device 13 adjacent to the shipment conveyor 15, and a shipment work area 12. The articles W transported to the article transport system 11 are loaded onto supports 2 (pallets in the embodiment) using the loading assistance device 1. The articles W loaded on the supports 2 are stored into the storage 16. The articles W shipped from the article transport system 11 are placed onto the shipment conveyor 15 from the storage 16. The articles W are then transported by the shipment conveyor 15 to the shipment work area 12, and shipped out of the article transport system 11 from the shipment work area 12. During transportation by the shipment conveyor 15, the articles W to be shipped are labeled by the attaching device 13. The articles W that have arrived at the shipment work area 12 are loaded onto, for example, a truck and transported to a destination.

The articles W loaded onto the supports 2 using the loading assistance device 1 may be directly transported to the shipment work area 12 by the shipment conveyor 15 without being stored into the storage 16. To ship the articles W, the articles W may be directly transported to the shipment work area 12 without being placed onto the shipment conveyor 15. In this case, the articles W are not labeled by the attaching device 13.

In the example in FIG. 1, the shipment conveyor 15 includes first outfeed conveyors 17, a second outfeed conveyor 18, and third outfeed conveyors 19. The first outfeed conveyors 17 are arranged adjacent to one another in the storage 16. Each first outfeed conveyor 17 is connected to the second outfeed conveyor 18 at its downstream end. The second outfeed conveyor 18 is adjacent to the attaching device 13. The second outfeed conveyor 18 is connected to the third outfeed conveyors 19 downstream from the attaching device 13. Each third outfeed conveyor 19 overlaps the shipment work area 12 when viewed in the vertical direction. More specifically, each article W placed on any of the first outfeed conveyors 17 is transported through the second outfeed conveyor 18 to any of the third outfeed conveyors 19. In the shipment work area 12, an operator unloads the articles W from the third outfeed conveyor 19, and loads the articles W onto, for example, a pallet or a cart. The shipment work area 12 allows a vehicle such as a truck to park and receive the loaded articles W for shipment. In the example in FIG. 1, the attaching device 13 is a labeler that automatically attaches a label indicating a destination to each article. The structure of the shipment conveyor 15 is appropriately rearrangeable.

The storage 16 stores the articles W loaded onto the support 2 by the loading assistance device 1. In the example in FIG. 1, multiple supports 2 are arranged in the storage 16, and multiple articles W are loaded onto each support 2. The storage 16 is located between the loading assistance device 1 and the shipment conveyor 15 (first outfeed conveyors 17 in this example). More specifically, the storage 16 is adjacent to the loading assistance device 1 and to the shipment conveyor 15. To transport the articles W loaded or not loaded onto the support 2 without using a conveyor inside the article transport system 11, for example, a forklift or an automated guided vehicle (AGV) may be used in addition to manual transport.

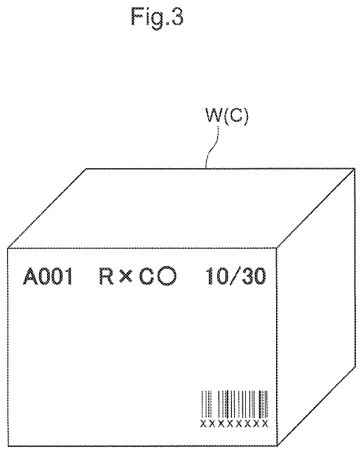

In the present embodiment, each article W is a container stackable on the support 2. More specifically, each article W is a carton C that accommodates items. In the example in FIG. 3, each article W is a cardboard box serving as the carton C. Examples of the items accommodated in the carton C include clothes, books, drinking water, foods, and machine parts.

The loading assistance device 1 assists in loading of multiple articles W each with readable identification information 91 indicating the category of the article onto the supports 2 based on the article category. In the present embodiment, the loading assistance device 1 assists in loading of multiple articles W (cartons C) onto the supports 2 (pallets) based on the article categories. In this example, as shown in FIG. 3, each carton C preliminarily has a linear code printed on its side surface. A reader 6 (described later) detects the linear code to obtain the identification information 91. The carton C may have, for example, a two-dimensional code in place of a linear code. In some embodiments, a label with such a linear code or a two-dimensional code printed may be preliminarily attached to the carton C. The loading assistance device 1 can assist in loading of the articles W in the same article category onto the support 2 or assist in loading of the articles W in different article categories onto the supports 2. Specific structures and features of the loading assistance device 1 will be described later. In accordance with predetermined criteria, the articles W to be handled with the loading assistance device 1 are sorted into the article categories. For example, the article categories may be based on a minimum management unit (stock keeping unit or SKU) of items (products) accommodated in each article W, or in other words, based on a minimum management unit for inventory management. In some embodiments, the article categories may be based on the identification code (for example, a product identification code such as a Japan Article Number or JAN code or a European Article Number or EAN code) of items accommodated in each article W. Although the supports 2 are pallets in the present embodiment, the supports 2 may be, for example, carts or racks.

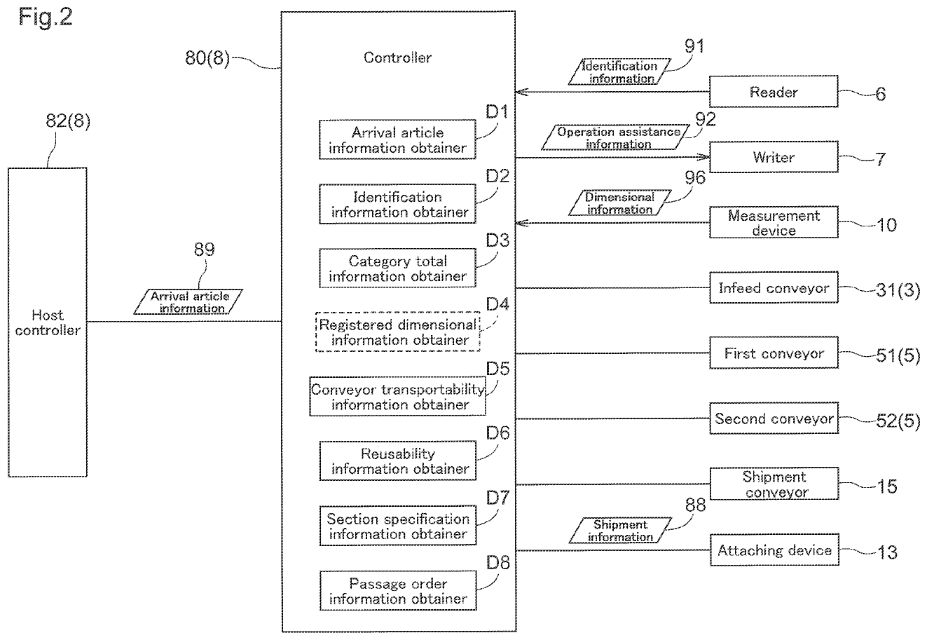

In the present embodiment, as shown in FIGS. 1 and 2, the loading assistance device 1 includes an infeed unit 3 to which the articles W are transported, a transporter 5, work areas 4, a reader 6, a writer 7, a measurement device 10, and a control system 8.

In the present embodiment, as shown in FIG. 1, the infeed unit 3 collectively receives multiple articles W in an article group Wg, which includes a set of multiple articles W. Each article W in the article group Wg is transported from the infeed unit 3 to the transporter 5. In this example, the infeed unit 3 includes multiple infeed conveyors 31. The infeed conveyors 31 are connected to the transporter 5. Each article W in the article group Wg transported to the infeed unit 3 is transported to the transporter 5 by the corresponding infeed conveyor 31. In the example in FIG. 1, the infeed unit 3 allows multiple vehicles (e.g., trucks) to park, and, for example, one or more article groups Wg are unloaded from a container on a single truck to spaces between the infeed conveyors 31. The operator then, for example, unloads the articles W in the article groups Wg and transfers the articles W to the infeed conveyors 31. One or more article groups Wg loaded on a single truck and transported to the infeed unit 3 are defined as one unit. The loading assistance device 1 can assist in loading for each unit. In some embodiments, the infeed unit 3 may allow a railway vehicle to park, and transport the article groups Wg from a container loaded on the railway vehicle.

As shown in FIG. 1, the transporter 5 transports the articles W from the infeed unit 3 to the work areas 4 along a predetermined transport path R. In the present embodiment, the transporter 5 includes a first conveyor 51 and multiple second conveyors 52. The first conveyor 51 connects the infeed unit 3 (more specifically, the infeed conveyors 31) to the second conveyors 52. Each of the multiple second conveyors 52 is connected to the first conveyor 51 to branch off (diverge) from an area downstream from the first conveyor 51. Each second conveyor 52 overlaps the corresponding work area 4 when viewed in the vertical direction. More specifically, the articles W pass, from the infeed conveyors 31 in the infeed unit 3, through the first conveyor 51 and the second conveyors 52 to the work areas 4. In the example in FIG. 1, alphabetical letters A, B, and C are sequentially assigned to the second conveyors 52 in order from the second conveyor 52 nearest the infeed unit 3. The second conveyor 52 may be referred to as a conveyor A or a conveyor B in order from the second conveyor 52 nearest the infeed unit 3. The transporter 5 may include one or more first conveyors 51 and one or more second conveyors 52. The transporter 5 may be an AGV that transports the articles W between the infeed unit 3 and the work areas 4.

As shown in FIG. 1, the operator performs loading in the work areas 4. More specifically, the operator loads the articles W transported to the work areas 4 onto the supports 2. Each work area 4 includes, along the transport path R, multiple work sections 9 in which the supports 2 are placed. In the present embodiment, the work sections 9 are arranged along the second conveyors 52. Each support 2 is placed in the corresponding work section 9, and the operator loads the articles W on the second conveyor 52 onto the support 2 placed in the work section 9. The multiple supports 2 are placed in the corresponding work sections 9 to be arranged along the transport path R of each second conveyor 52.

In this example, the work sections 9 are located on both sides of the transport path R. In the example in FIG. 1, the work sections 9 are arranged along the transport path R (in the transport direction of each second conveyor 52 in this example) and on both sides of the second conveyor 52. In the example in FIG. 1, ten work sections 9 are located with five on each side of the conveyors A to C of the second conveyors 52. As described above, the supports 2 shown in FIG. 1 are pallets. In FIG. 1, for illustration of section specification information 93 (described later), the numbers 1 to 10 are assigned to the ten work sections 9 arranged along the conveyor A of the second conveyors 52. Similarly, the numbers 1 to 5 are assigned to five of the ten work sections 9 arranged along the conveyor B of the second conveyors 52.

The reader 6 is located along the transport path R to read the identification information 91 on each article W. In the present embodiment, the reader 6 is located adjacent to the transporter 5 (first conveyor 51 in this example). The reader 6 is located on the transport path R upstream from the measurement device 10 and the writer 7. In this example, as described above, the reader 6 reads the linear code printed on each article W. The reader 6 may read a two-dimensional code printed on each article W. The reader 6 may be a scanner for an integrated circuit (IC) tag such as radio frequency identification (RFID). In this case, each article W in the article group Wg receives an IC tag. The reader 6 may be an image recognizer that recognizes characters or patterns on the surface of the article W. In the present embodiment, the reader 6 reads the identification information 91 on each article W transported by the first conveyor 51, and transmits the identification information 91 to a controller 80 (described later). The identification information 91 may include, for example, the article category (e.g., a product name or a product name code) of the article W. Thus, the controller 80 can identify the article category of the article W that has passed the reader 6. In this example, the identification information 91 may include information about the article category of the article W read by the reader 6 and about the order of the article W at which it has passed the reader 6 among the articles W in the same article category.

The writer 7 is located between the reader 6 and the work areas 4 along the transport path R, and writes operation assistance information 92 on the surface of each article W. In the present embodiment, the writer 7 is located on the transport path R between the measurement device 10 and the work areas 4. The writer 7 is adjacent to the transporter 5 (the first conveyor 51 in this example). In this example, the writer 7 is located on the transport path R downstream from the measurement device 10 and the reader 6. In the present embodiment, the writer 7 is a printer 71 that prints the operation assistance information 92 on the surface of each carton C. As shown in FIG. 3, the writer 7 (printer 71) prints the operation assistance information 92 on a side surface of each article W (carton C) transported by the first conveyor 51. The writer 7 (printer 71) is an inkjet printer in this example, but may be, for example, a device (e.g., an automatic labeler) that attaches a label with the operation assistance information 92 to the surface of each carton C. The operation assistance information 92 is described later in detail.

In the present embodiment, as shown in FIGS. 1 and 2, the loading assistance device 1 includes at least one of a registered dimensional information obtainer D4 that acquires dimensional information 96 indicating the outer dimensions of each article W for each preregistered article category or the measurement device 10 located on the transport path R upstream from the writer 7 to acquire the dimensional information 96 by measuring the outer dimensions of each article W transported by the transporter 5. In this example, the loading assistance device 1 includes the measurement device 10 as described above. The measurement device 10 is located on the transport path R between the reader 6 and the writer 7. The measurement device 10 is located along the transporter 5 (first conveyor 51 in this example). The measurement device 10 is a laser measuring device including a light emitter and a light receiver. The light emitter and the light receiver are located across the first conveyor 51. The measurement device 10 measures the dimensions (the height, width, and depth) of each article W (carton C) transported by the first conveyor 51, and transmits the dimensional information 96 to the controller 80.

The operation assistance information 92 will now be described. The operation assistance information 92 includes the section specification information 93 that specifies the work section 9 where each article W is to be loaded. In the example in FIG. 3, the article W (carton C) has A001 printed as the section specification information 93 on its side surface. The work section 9 specified with A001 is the work section 9 numbered 1 among the work sections 9 arranged along the conveyor A of the second conveyors 52. In this case, the article W is automatically transported from the first conveyor 51 to the conveyor A of the second conveyors 52. The operator receives the article from the conveyor A of the second conveyors 52, visually checks the printed number 001, and loads the received article W onto the support 2 placed in the work section 9 numbered 1 (refer to FIG. 1). For the article W with B003 printed on its side surface, for example, the article W is automatically transported from the first conveyor 51 to the conveyor B of the second conveyors 52. The operator receives the article W from the conveyor B of the second conveyors 52, visually checks the printed number 003, and loads the received article W onto the support 2 placed in the work section 9 numbered 3. In this manner, the operator refers to the section specification information 93 to determine, of the multiple work sections 9, the work section 9 for loading and thus can determine the support 2 onto which the article W is to be loaded. The articles W transported by the transporter 5 may be hereafter referred to as a target article Wt.

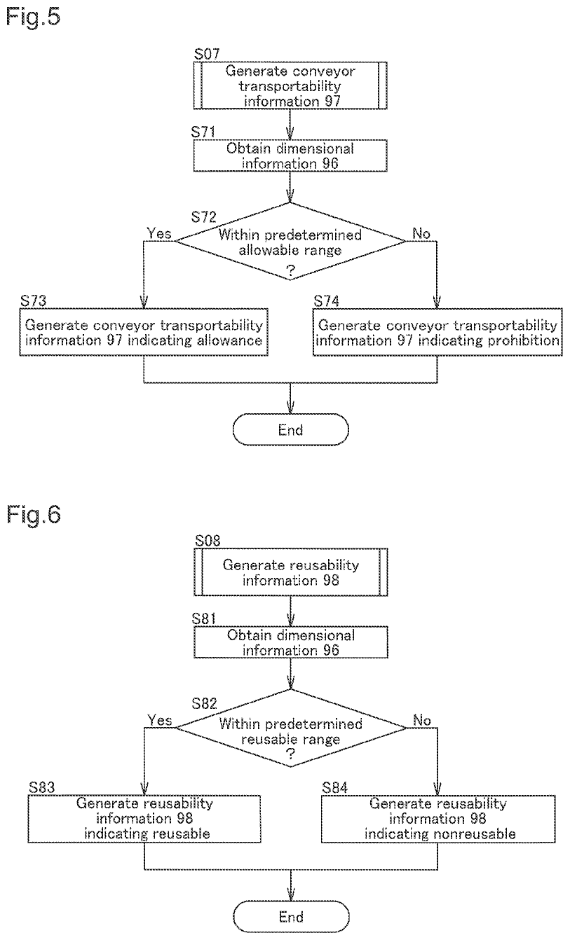

In the present embodiment, as shown in FIGS. 3 and 5, the operation assistance information 92 includes passage order information 95 indicating the relationship between the transport order of the target article Wt among the articles W in the same article category and the total quantity per category. As described later, the total quantity per category is the quantity of the articles W in each article category included in the article group Wg transported to the infeed unit 3. In this example, the transport order of the target article Wt and the total quantity per category (the transport order/the total quantity per category in FIG. 3) are printed on a side surface of each article W as the passage order information 95. In the example in FIG. 3, the article W has 10/30 printed on its side surface. This indicates that the total quantity of the target articles Wt in the same article category is 30, and the target article Wt passes the writer 7 in the tenth position. In other words, the operator who loads this article W onto the support 2 in the work area 4 can estimate, by visually checking the passage order information 95, nine articles W among the target articles Wt in the same article category that have already been loaded on the support 2. The operator can also estimate 20 more target articles Wt to be loaded onto the support 2. When loading, for example, a target article Wt with 30/30, the operator can recognize that no more article W in the same article category as the target article Wt is to be transported to the work area 4.

The operation assistance information 92 includes conveyor transportability information 97 indicating whether, after the article W supported on the support 2 in the work area 4 is unloaded from the support 2 for a shipment operation, the article W is allowed to be transported by the shipment conveyor 15 to the shipment work area 12, where the shipment operation is to be performed. In this example, the article W allowed to be transported by the shipment conveyor 15 can be placed onto the shipment conveyor 15, whereas the article W not allowed to be transported by the shipment conveyor 15 is prohibited from being placed onto the shipment conveyor 15. In the example in FIG. 3, the article W (carton C) has a letter C with a circle printed on its side surface. In this case, the article W is allowed to be transported by the shipment conveyor 15. The operator visually checks the printed letter C with a circle for shipment, and transfers the article W loaded on the support 2 from, for example, the storage 16 to the shipment conveyor 15 (first outfeed conveyor 17 in this example). For an article W with a letter C with a cross printed on its side surface, the article W is prohibited from being transported by the shipment conveyor 15. Thus, the operator directly transports the article W to the shipment work area 12 without placing the article W onto the shipment conveyor 15 (first outfeed conveyor 17 in this example).

The operation assistance information 92 includes reusability information 98 indicating whether the carton C as the article W is reusable. In the example in FIG. 3, the article W has a letter R with a cross printed on its side surface. In this case, the article W is recognized as being nonreusable. For an article W with a letter R with a circle printed on its side surface, the article W is recognized as being reusable. In the present embodiment, reusing includes reusing an empty carton C from which all the accommodated items are removed to accommodate new items. Reusing may also include recycling an empty carton C.

In this example, examples of the operation assistance information 92 include the section specification information 93, the passage order information 95, the conveyor transportability information 97, and the reusability information 98 printed on all the articles W included in one unit (e.g., all the article groups Wg loaded on a truck).

As shown in FIG. 2, the control system 8 controls the reader 6 and the writer 7. In the present embodiment, the control system 8 includes the controller 80, which controls the reader 6 and the writer 7. The controller 80 also controls the measurement device 10, the infeed conveyors 31, the first conveyor 51, the second conveyors 52, the shipment conveyors 15, an outfeed conveyor 14, and the attaching device 13. The control system 8 further includes a host controller (hereafter referred to as a host controller 82) that can communicate with the controller 80. The controller 80 obtains arrival article information 89 (described later) from the host controller 82. The controller 80 includes a computation processor such as a central processing unit (CPU) and a peripheral circuit such as a memory. The controller 80 implements its functions in cooperation with these pieces of hardware and programs executed on the hardware such as the computation processor. The controller 80 may include a group of multiple pieces of hardware (multiple separate pieces of hardware) that can communicate with one another, rather than a single piece of hardware.

In the present embodiment, as shown in FIG. 2, the controller 80 includes an arrival article information obtainer D1, an identification information obtainer D2, a category total information obtainer D3, a conveyor transportability information obtainer D5, a reusability information obtainer D6, a section specification information obtainer D7, and a passage order information obtainer D8. The controller 80 may also include the registered dimensional information obtainer D4 (indicated by the dashed line in FIG. 2).

The control system 8 generates the section specification information 93 to be written on each article W to preferentially load the articles W in the same article category onto the same support 2 based on the identification information 91 read by the reader 6. In the present embodiment, the controller 80 generates the section specification information 93 for each target article Wt based on category total information 94 (described later) and the identification information 91. The controller 80 generates the section specification information 93 for the target articles Wt in the same article category to preferentially load the target articles Wt onto the support 2 (pallet) in the same work section 9. For example, the controller 80 generates the section specification information 93 to load the maximum loadable quantity of articles W in the same article category onto a single support 2. When the quantity of the articles W in the same article category exceeds the maximum quantity, the controller 80 generates the section specification information 93 to load the excess articles W onto another support 2. When the total quantity of the articles W in the same article category loaded on a single support 2 is less than the maximum quantity, the controller 80 generates the section specification information 93 to allow, for example, the articles W in another article category to be loaded onto this support 2 (in other words, to load the articles W in different article categories together onto a single support 2).

For example, when the maximum quantity of the articles W loadable on each support 2 is 10, and the total quantity of the articles W in a predetermined article category based on the category total information 94 is 12, the controller 80 can assign 10 of the 12 articles W to be loaded onto the support 2 with A001 printed, and can assign the remaining two articles W to be loaded onto the support 2 with A002 printed. The controller 80 determines, based on the identification information 91 on the target article Wt transported by the transporter 5, that the target article Wt is included in a predetermined article category and the order of the target article Wt that has passed the reader 6 among the articles W in the predetermined article category, and generates the section specification information 93 to be printed on the article W. In the above example, the writer 7 prints A001 on up to the tenth target articles Wt, and prints A002 on the eleventh and subsequent target articles Wt. Thus, the controller 80 sequentially generates the section specification information 93 to be printed on the target articles Wt that pass the reader 6. The section specification information 93 is generated and obtained by the section specification information obtainer D7.

In the present embodiment, the control system 8 obtains the category total information 94 indicating the total quantity per category, or the quantity of the articles W in each article category included in the article group Wg upon the article group Wg being transported to the infeed unit 3. In this example, the controller 80 generates and obtains the category total information 94 with the category total information obtainer D3. More specifically, when one or more article groups Wg (one unit of the article groups Wg in this example) are transported to the infeed unit 3, the controller 80 obtains the arrival article information 89 (arrival article information 89 for the article groups Wg in one unit in this example) from the host controller 82. The arrival article information 89 may include, for example, the article category (e.g., a product name or a product code) included in the article group Wg, the quantity of the articles W in each article category (total quantity per category), and best-before date of items accommodated in the articles W. The arrival article information 89 is generated and obtained by the arrival article information obtainer D1. For example, when the article category that is the quantity of articles in each article category is known for all the multiple article groups Wg (in other words, one unit of the article groups Wg) loaded on a truck parked alongside the infeed unit 3, such information is preliminarily transmitted to or input into the controller 80 to generate the arrival article information 89. In this example, the category total information 94 is generated based on the arrival article information 89. More specifically, the category total information 94 is generated and obtained by extracting the quantity of the articles W in each article category (total quantity per category) from the arrival article information 89 obtained by the host controller 82.

The control system 8 determines the transport order of the target article Wt based on the identification information 91 on the target article Wt read by the reader 6 and on the identification information 91 on the article W read by the reader 6 before the target article Wt is read, and generates the passage order information 95 based on the transport order and the total quantity per category based on the category total information 94. More specifically, the controller 80 determines the order (transport order) in which the target article Wt currently read by the reader 6 passes the reader 6 using the identification information 91 on one or more target articles Wt in the same article category that have already been read by the reader 6. Based on the determined transport order and the total quantity per category, the controller 80 then generates the passage order information 95 including information (transport order information) indicating the order in which the target article Wt passes the reader 6 among all the target articles Wt in the same article category. The passage order information 95 is generated and obtained by the passage order information obtainer D8. The passage order information 95 may also include information (passage schedule information) indicating the quantity of the target articles Wt in the same article category that are to pass the reader 6.

When the outer dimensions of the article W indicated by the dimensional information 96 obtained from at least one of the registered dimensional information obtainer D4 or the measurement device 10 are within a predetermined allowable range, the control system 8 generates the conveyor transportability information 97 indicating that the target article Wt is allowed to be transported by the shipment conveyor 15. When the outer dimensions of the article W indicated by the dimensional information 96 are out of the predetermined allowable range, the control system 8 generates the conveyor transportability information 97 indicating that the target article Wt is prohibited from being transported by the shipment conveyor 15. In this example, the controller 80 generates the conveyor transportability information 97 based on the dimensional information 96 obtained from the measurement device 10. As described above, the dimensional information 96 includes the outer dimensions (the height, width, and depth) of the target article Wt (carton C) measured by the measurement device 10. When the outer dimensions of the target article Wt are within a range of the predetermined dimensions preliminarily stored in the controller 80, the controller 80 generates the conveyor transportability information 97 indicating that the target article Wt is allowed to be transported by the shipment conveyor 15 (first outfeed conveyor 17 in this example). In the example in FIG. 3, the article W has a letter C with a circle printed as an example of the conveyor transportability information 97. When the outer dimensions of the target article Wt are out of the range of the predetermined dimensions, the controller 80 generates the conveyor transportability information 97 indicating that the target article Wt is prohibited from being transported by the shipment conveyor 15 (first outfeed conveyor 17). The conveyor transportability information 97 is generated and obtained by the conveyor transportability information obtainer D5. In the example in FIG. 1, the attaching device 13 attaches a label indicating a destination to the target article Wt transported to the shipment conveyor 15. More specifically, the predetermined dimensions preliminarily stored in the controller 80 are set based on whether the attaching device 13 can attach a label of a predetermined size to the surface of each carton C. As shown in FIG. 2, the controller 80 can obtain shipment information 88 on each target article Wt, and transmit the shipment information 88 to the attaching device 13. Based on the shipment information 88 received from the controller 80, the attaching device 13 produces a label indicating the destination, and attaches the label to the article W that passes the attaching device 13.

When the outer dimensions of the article W indicated by the dimensional information 96 obtained from at least one of the registered dimensional information obtainer D4 or the measurement device 10 are within a predetermined reusable range, the control system 8 generates the reusability information 98 indicating that the carton C as the target article Wt is reusable. When the outer dimensions of the article W indicated by the dimensional information 96 are out of the reusable range, the control system 8 generates the reusability information 98 indicating that the carton C being the target article Wt is nonreusable. In this example, the controller 80 generates the reusability information 98 based on the dimensional information 96 obtained from the measurement device 10. As described above, the dimensional information 96 includes the outer dimensions (the height, width, and depth) of the target article Wt (carton C) measured by the measurement device 10. When the outer dimensions of the target article Wt are within a reusable range of the predetermined dimensions preliminarily stored in the controller 80, the controller 80 generates the reusability information 98 indicating that the target article Wt accommodating no items is reusable (in other words, can accommodate items again). When the outer dimensions of the target article Wt are out of the reusable range of the predetermined dimensions, the controller 80 generates the reusability information 98 indicating that the target article Wt is nonreusable. In the example in FIG. 3, the article W has a letter R with a cross printed as an example of the reusability information 98.

The conveyor transportability information 97 and the reusability information 98 may be generated based on a comparison between the predetermined dimensions preliminarily stored in the controller 80 and the profile of the article W captured by, for example, an image capturing device, instead of using the measurement device 10.

As described above, when the section specification information 93, the passage order information 95, the conveyor transportability information 97, and the reusability information 98 are generated, the controller 80 transmits all these pieces of information to the writer 7 as the operation assistance information 92, and controls the writer 7 to print the operation assistance information 92 on the target article Wt that passes the writer 7.

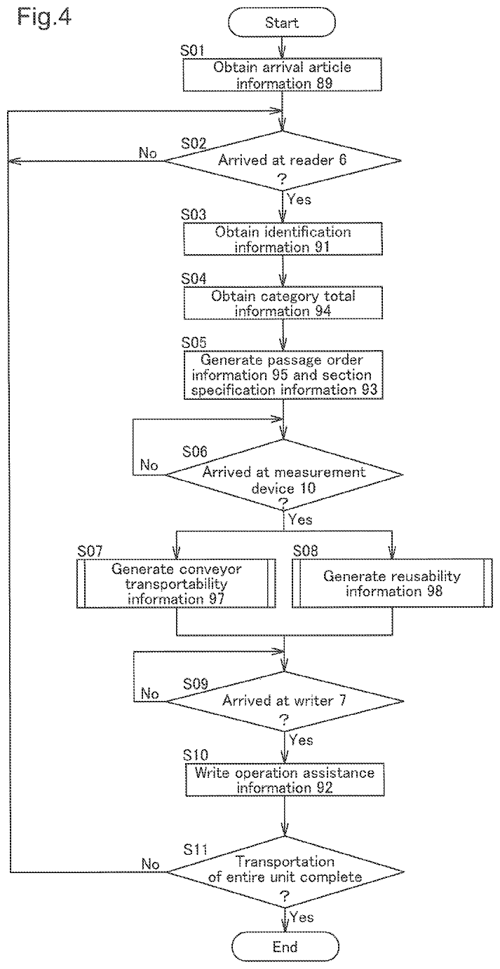

In the present embodiment, as shown in FIG. 4, when one unit of the article groups Wg is transported to the infeed unit 3, the controller 80 obtains the arrival article information 89 from the host controller 82 (S01). In the infeed unit 3, the operator then sequentially places the articles W included in one or more article groups Wg onto the infeed conveyor 31. The articles W are then transported from the infeed conveyor 31 to the first conveyor 51. When determining that the article W (target article Wt in this example) has arrived at the reader 6 in the first conveyor 51 (Yes in S02), the controller 80 obtains the identification information 91 from the reader 6 (S03). The controller 80 then obtains the generated category total information 94 (S04), and generates the passage order information 95 and the section specification information 93 (505). When determining that the target article Wt has arrived at the measurement device 10 (Yes in S06), the controller 80 generates the conveyor transportability information 97 (S07) and the reusability information 98 (S08). When determining that the target article Wt has arrived at the writer 7 (Yes in S09), the controller 80 controls the writer 7 to write the operation assistance information 92 on the target article Wt (S10). The controller 80 then determines whether transportation of the entire unit is complete (S11). More specifically, one or more article groups Wg loaded on a single truck parked at the infeed unit 3 is defined as one unit, and the controller 80 determines whether all the articles W included in one unit have been transported from the infeed unit 3 to the work area 4. When determining that transportation of the entire unit of the target articles Wt is not complete (No in S11), the controller 80 determines whether the target article Wt to be subsequently transported to the reader 6 has arrived at the reader 6 (S02). When determining that transportation of the entire unit of the target articles Wt is complete (Yes in S11), the controller 80 ends the control processing. Although the example in FIG. 4 shows the control processing performed by the controller 80 on one unit, for example, multiple trucks may be parked at the infeed unit 3. In such a case, the controller 80 may perform the control shown in FIG. 4 on multiple units in parallel.

The control of a process (S07) of generating the conveyor transportability information 97 will now be described. After obtaining the dimensional information 96 about the target article Wt from the measurement device 10 (S71), the controller 80 determines whether the outer dimensions of the target article Wt are within a predetermined allowable range (S72). When determining that the outer dimensions of the target article Wt are within the predetermined allowable range (Yes in S72), the controller 80 generates the conveyor transportability information 97 indicating that the target article Wt is allowed to be transported by the shipment conveyor 15 (S73). When determining that the outer dimensions of the target article Wt are out of the predetermined allowable range (No in S72), the controller 80 generates the conveyor transportability information 97 indicating that the target article Wt is prohibited from being transported by the shipment conveyor 15 (S74).

The control of a process (S08) of generating the reusability information 98 will now be described. In response to the dimensional information 96 about the target article Wt obtained from the measurement device 10 (S81), the controller 80 determines whether the outer dimensions of the target article Wt are within a predetermined reusable range (S82). When determining that the outer dimensions of the target article Wt are within the predetermined reusable range (Yes in S82), the controller 80 generates the reusability information 98 indicating that the target article Wt is reusable (S83). When determining that the outer dimensions of the target article Wt are out of the predetermined reusable range (No in S82), the controller 80 generates the reusability information 98 indicating that the target article Wt is nonreusable (S84).
(1) In the above embodiments, the work sections 9 are located on both sides of each transport path R, but the embodiments are not limited to this example. For example, the work sections 9 may be located on one side of each transport path R. The work sections 9 may not be arranged along the multiple second conveyors 52, and the work sections 9 may be arranged along a single second conveyor 52.
(2) In the above embodiments, upon the article group Wg being transported to the infeed unit 3, the control system 8 obtains the category total information 94 indicating the total quantity per category that is the quantity of the articles W in each article category included in the transported article group Wg, but the embodiments are not limited to this example. For example, the control system 8 may preliminarily obtain the category total information 94 about the articles W that are to be transported to the infeed unit 3 within a predetermined period. When the predetermined period is set as one day, the control system 8 may preliminarily obtain the category total information 94 about the articles W that are to be transported to the infeed unit 3 in one day, for example, the day before the transportation day or in the morning of the transportation day. Such a predetermined period may be set as, for example, a week or an hour as appropriate, instead of a day.
(3) In the above embodiments, the control system 8 generates the conveyor transportability information 97 based on the dimensional information 96 obtained from the measurement device 10, but the embodiments are not limited to this example. The control system 8 may include the registered dimensional information obtainer D4 (indicated by the dashed line in FIG. 2), and generate the conveyor transportability information 97 based on the dimensional information 96 obtained from the registered dimensional information obtainer D4. For example, the arrival article information 89 obtained by the controller 80 from the host controller 82 may include the outer dimensions of each target article Wt, and the registered dimensional information obtainer D4 may generate and obtain the dimensional information 96 from the outer dimensions of the target article Wt extracted from the arrival article information 89. The control system 8 may generate the conveyor transportability information 97 based on the dimensional information 96 generated and obtained by the registered dimensional information obtainer D4 and the dimensional information 96 obtained from the measurement device 10. In addition to the dimensional information 96, for example, the control system 8 may generate the conveyor transportability information 97 based on weight information. In this case, the arrival article information 89 may include the weight of each target article Wt, or the measurement device 10 may measure the weight of the target article Wt.
(4) In the above embodiments, the control system 8 generates the reusability information 98 based on the dimensional information 96 obtained from the measurement device 10, but the embodiments are not limited to this example. The control system 8 may include the registered dimensional information obtainer D4 (indicated by the dashed line in FIG. 2), and may generate the reusability information 98 based on the dimensional information 96 obtained from the registered dimensional information obtainer D4. For example, the arrival article information 89 obtained by the controller 80 from the host controller 82 may include the outer dimensions of each target article Wt, or the registered dimensional information obtainer D4 may generate and obtain the dimensional information 96 from the outer dimensions of the target article Wt extracted from the arrival article information 89. The control system 8 may generate the reusability information 98 based on the dimensional information 96 generated and obtained by the registered dimensional information obtainer D4 and the dimensional information 96 obtained from the measurement device 10. The control system 8 may generate the reusability information 98 based on weight information in addition to, for example, the dimensional information 96. In this case, the arrival article information 89 may include the weight of each target article Wt, or the measurement device 10 may measure the weight of each target article Wt.
(5) In the above embodiments, each article W is the carton C that accommodates items, but the embodiments are not limited to this example. The article W may be, for example, a resin container that accommodates items. The article W may be a product loadable onto the support 2, rather than a container.
(6) The structure described in each of the above embodiments may be combined with any other structures described in the other embodiments unless any contradiction arises. This also applies to combinations of the embodiments described as other embodiments. The embodiments described herein are merely illustrative in all respects and may be modified variously as appropriate without departing from the spirit and scope of the present disclosure.

### Overview of Embodiments

The loading assistance device described above is overviewed below.

A loading assistance device according to an embodiment of the present disclosure is a loading assistance device for assisting in loading of a plurality of articles each with identification information indicating a category of the article onto supports based on the article category. The identification information is readable. The loading assistance device includes an infeed unit to which the plurality of articles are transported, a work area in which an operator performs the loading, a transporter that transports the plurality of articles from the infeed unit to the work area along a predetermined transport path, a reader located along the transport path to read the identification information on the plurality of articles, a writer located between the reader and the work area along the transport path to write operation assistance information on a surface of each of the plurality of articles, and a control system that controls the reader and the writer. The work area includes, along the transport path, a plurality of work sections in which the supports are placed. The operation assistance information includes section specification information specifying a work section of the plurality of work sections for each of the plurality of articles to undergo the loading. The control system generates the section specification information to be written on each of the plurality of articles based on the identification information read by the reader to allow articles in a same category to be preferentially loaded onto a same support of the supports.

The device with this structure writes, on the surface of each article, the operation assistance information including section specification information that specifies the work section for loading the article. The article with the operation assistance information is transported to the work area by the transporter. Thus, for example, the operator simply performing an operation in the work area based on the operation assistance information on each article can preferentially load the articles in the same article category onto the same support. The device can thus facilitate loading performed by, for example, the operator, and reduce loading errors caused by, for example, the operator.

Thus, the loading assistance device with this structure is awaited for facilitating loading of articles based on their article categories and for improving loading accuracy.

The infeed unit may collectively receive articles in an article group. The article group may include a set of articles of the plurality of articles. Upon the article group being transported to the infeed unit, the control system may obtain category total information indicating a total quantity per category being a quantity of articles in each article category included in the article group transported to the infeed unit. The operation assistance information may include passage order information indicating a relationship between the total quantity per category and a transport order of a target article among the articles in the same article category, where the target article is each of the plurality of articles transported by the transporter. The control system may determine the transport order of the target article based on the identification information on the target article read by the reader and the identification information on an article of the plurality of articles read by the reader before the identification information on the target article is read, and generate the passage order information based on the transport order and the total quantity per category indicated by the category total information.

In this structure, each article is transported to the work area by the transporter with the passage order information indicating the relationship between the transport order of the target article in the articles in the same article category and the total quantity per category written on its surface. Thus, the operator in the work area can easily check the transportation order of the article among the articles in the same article category based on the operation assistance information on the article. In addition, the operator can easily check whether the loading of all the articles in the same article category is complete. This structure can thus more effectively facilitate loading performed by the operator and reduce errors caused by the operator.

The loading assistance device may further include at least one of a registered dimensional information obtainer or a measurement device. The registered dimensional information obtainer may obtain dimensional information about each article in each article category preregistered. The dimensional information may indicate outer dimensions of each of the plurality of articles. The measurement device may obtain the dimensional information by measuring outer dimensions of each of the plurality of articles transported by the transporter at a position on the transport path upstream from the writer. The operation assistance information may include conveyor transportability information indicating whether, after each of the plurality of articles supported on the support in the work area is unloaded from the support for a shipment operation, the article is allowed to be transported by a shipment conveyor for article transportation to a shipment work area in which the shipment operation is performed. When the outer dimensions of each of the plurality of articles indicated by the dimensional information obtained from at least one of the registered dimensional information obtainer or the measurement device are within a predetermined allowable range, the control system may generate the conveyor transportability information indicating that a target article is allowed to be transported by the shipment conveyor, where the target article is each of the plurality of articles transported by the transporter. When the outer dimensions of each of the plurality of the articles indicated by the dimensional information are out of the predetermined allowable range, the control system may generate the conveyor transportability information indicating that the target article is prohibited from being transported by the shipment conveyor.

In this structure, each article is transported by the transporter to the work area and loaded onto the support with the conveyor transportability information indicating whether the article is allowed to be transported by the shipment conveyor written on its surface. Thus, the operator that has unloaded the article from the support for shipment of the article can easily determine whether the article is allowed to be transported by the shipment conveyor based on the operation assistance information on the article. This structure can thus facilitate the operation performed by the operator for shipment of the article, and reduce errors caused by the operator such as placing an article prohibited from being transported by the shipment conveyor onto the shipment conveyor.

The loading assistance device may further include at least one of a registered dimensional information obtainer or a measurement device. The registered dimensional information obtainer may obtain dimensional information about each article in each article category preregistered. The dimensional information may indicate outer dimensions of each of the plurality of articles. The measurement device may obtain the dimensional information by measuring outer dimensions of each of the plurality of articles transported by the transporter at a position on the transport path upstream from the writer. The plurality of articles may be cartons accommodating items. The operation assistance information may include reusability information indicating whether each of the cartons being the plurality of articles is reusable. When the outer dimensions of each of the plurality of articles indicated by the dimensional information obtained from at least one of the registered dimensional information obtainer or the measurement device are within a predetermined reusable range, the control system may generate the reusability information indicating that the carton being a target article is reusable, where the target article is each of the plurality of articles transported by the transporter. When the outer dimensions of each of the plurality of articles indicated by the dimensional information are out of the predetermined reusable range, the control system may generate the reusability information indicating that the carton being the target article is nonreusable.

In this structure, each article is transported by the transporter to the work area and loaded onto the support with the reusability information indicating whether the carton being the article is reusable written on its surface. Thus, the operator that has unloaded all the items from the carton being the article can easily determine whether to reuse the carton based on the operation assistance information on the carton. This structure can thus facilitate a process performed by the operator on the carton, and reduce errors caused by the operator such as reusing a nonreusable carton.

The plurality of articles may be cartons accommodating items. The writer may be a printer that prints the operation assistance information on surfaces of the cartons.

In this structure, the article can appropriately have the operation assistance information written on its surface.

The loading assistance device according to one or more embodiments of the present disclosure may produce at least one of the effects described above.

What is claimed is:

1. A loading assistance device for assisting in loading of a plurality of articles each with identification information indicating a category of the article onto supports based on the article category, the identification information being readable, the loading assistance device comprising:
an infeed unit to which the plurality of articles are transported;
a work area in which an operator performs the loading;
a transporter configured to transport the plurality of articles from the infeed unit to the work area along a predetermined transport path;
a reader located along the transport path, the reader configured to read the identification information on the plurality of articles;
a writer located between the reader and the work area along the transport path, the writer configured to write operation assistance information on a surface of each of the plurality of articles; and
a control system configured to control the reader and the writer, and
wherein:
the work area comprises, along the transport path, a plurality of work sections in which the supports are placed,
the operation assistance information includes section specification information specifying a work section of the plurality of work sections for each of the plurality of articles to undergo the loading, and
the control system generates the section specification information to be written on each of the plurality of articles based on the identification information read by the reader to allow articles in a same category to be preferentially loaded onto a same support of the supports.

2. The loading assistance device according to claim 1, wherein:
the infeed unit collectively receives articles in an article group, and the article group includes a set of articles of the plurality of articles,
upon the article group being transported to the infeed unit, the control system obtains category total information indicating a total quantity per category being a quantity of articles in each article category included in the article group transported to the infeed unit,
the operation assistance information includes passage order information indicating a relationship between the total quantity per category and a transport order of a target article among the articles in the same article category, where the target article is each of the plurality of articles transported by the transporter, and
the control system determines the transport order of the target article based on the identification information on the target article read by the reader and the identification information on an article of the plurality of articles read by the reader before the identification information on the target article is read, and generates the passage order information based on the transport order and the total quantity per category indicated by the category total information.

3. The loading assistance device according to claim 1, further comprising:
at least one of a registered dimensional information obtainer or a measurement device, the registered dimensional information obtainer configured to obtain dimensional information about each article in each article category preregistered, the dimensional information indicating outer dimensions of each of the plurality of articles, the measurement device configured to obtain the dimensional information by measuring outer dimensions of each of the plurality of articles transported by the transporter at a position on the transport path upstream from the writer,
wherein the operation assistance information includes conveyor transportability information indicating whether, after each of the plurality of articles supported on the support in the work area is unloaded from the support for a shipment operation, the article is allowed to be transported by a shipment conveyor for article transportation to a shipment work area in which the shipment operation is performed, and
wherein when the outer dimensions of each of the plurality of articles indicated by the dimensional information obtained from at least one of the registered dimensional information obtainer or the measurement device are within a predetermined allowable range, the control system generates the conveyor transportability information indicating that a target article is allowed to be transported by the shipment conveyor, where the target article is each of the plurality of articles transported by the transporter, and when the outer dimensions of each of the plurality of the articles indicated by the dimensional information are out of the predetermined allowable range, the control system generates the conveyor transportability information indicating that the target article is prohibited from being transported by the shipment conveyor.

4. The loading assistance device according to claim 1, further comprising:
at least one of a registered dimensional information obtainer or a measurement device, the registered dimensional information obtainer configured to obtain dimensional information about each article in each article category preregistered, the dimensional information indicating outer dimensions of each of the plurality of articles, the measurement device configured to obtain the dimensional information by measuring outer dimensions of each of the plurality of articles transported by the transporter at a position on the transport path upstream from the writer and,
wherein:
the plurality of articles are cartons accommodating items,
the operation assistance information includes reusability information indicating whether each of the cartons being the plurality of articles is reusable, and
when the outer dimensions of each of the plurality of articles indicated by the dimensional information obtained from at least one of the registered dimensional information obtainer or the measurement device are within a predetermined reusable range, the control system generates the reusability information indicating that the carton being a target article is reusable, where the target article is each of the plurality of articles transported by the transporter, and when the outer dimensions of each of the plurality of articles indicated by the dimensional information are out of the predetermined reusable range, the control system generates the reusability information indicating that the carton being the target article is nonreusable.

5. The loading assistance device according to claim 1, wherein:
the plurality of articles are cartons accommodating items, and
the writer is a printer configured to print the operation assistance information on surfaces of the cartons.
